(19) United States
(12) Patent Application Publication
(10) Pub. No.: US 2013/0341370 A1
(43) Pub. Date: Dec. 26, 2013

(54) SHOPPING CART ORGANIZER

(71) Applicant: Robert J. Larson, Coon Rapids, MN (US)

(72) Inventor: Robert J. Larson, Coon Rapids, MN (US)

(21) Appl. No.: 13/852,870

(22) Filed: Mar. 28, 2013

Related U.S. Application Data
(60) Provisional application No. 61/616,720, filed on Mar. 28, 2012.

(51) Int. Cl. B62B 5/00

(52) U.S. Cl. CPC B62B 5/00
USPC 224/411

(57) ABSTRACT

An organizer attachment for a shopping cart for securing desired items, such as a grocery list and/or shopping coupons, as well as possibly other device such as a writing utensil, locator, calculator, or price tracker. The organizer attachment is coupled to a desired surface, such as a portion of a shopping cart. The organizer may be removable or positionable to accommodate a stored configuration of the cart. The organizer includes one or more retention areas for retaining the desired items to the organizer.

### CROSS REFERENCE TO RELATED APPLICATIONS

The present application claims benefit under 35 U.S.C. 119(e) for a right of priority to U.S. Provisional Application No. 61/616,720, filed Mar. 28, 2013, entitled “Shopping Cart Organizer,” which is incorporated herein by reference in its entirety.

### SUMMARY

An organizer is described for attachment to a conventional shopping cart. The organizer may include a generally rigid material for securely retaining coupons during the shopping experience. The rigid material may be generally planar with a top edge, bottom edge, two lateral edges, and a bottom face and top face.

Exemplary embodiments of the organizer may include elastic bands, elastic cords, springs, clips and/or clamps molded, fastened and/or coupled to the organizer for securing coupons to the organizer while the shopping cart is in use and in motion.

To this end, in an exemplary embodiment of the present invention, an organizer, comprising: a rigid material; a retention feature configured to retain an inserted material between the retention feature and the rigid material; and a connector to couple the organizer to a desired surface.

In an exemplary embodiment, wherein the retention feature comprises an elastic material.

In an exemplary embodiment, wherein the rigid material includes a plurality of holes and the elastic material is threaded through the holes and configured to provide at least two retention areas on a first surface of the rigid material.

In an exemplary embodiment, wherein at least one of the plurality of holes includes a tab for retaining the elastic material.

In an exemplary embodiment, wherein the elastic material is oriented through the plurality of holes to create at least three retention areas on the first surface of the rigid material.

In an exemplary embodiment, wherein the rigid material includes a holder for a writing utensil.

In an exemplary embodiment, wherein the holder is a hole through the rigid material and the writing utensil is retained in the hole by a grommet.

In an exemplary embodiment, wherein the connector is at a first end of the organizer and comprises a clip.

In an exemplary embodiment, further comprising a second connector on an opposite end of the organizer than the connector.

In an exemplary embodiment, wherein the rigid material is separable into a first rigid material and a second rigid material.

In an exemplary embodiment, wherein the first rigid material and second rigid material mate in an expanded configuration for use and retract into a collapsed configuration for storage.

In an exemplary embodiment, wherein the first rigid material comprises an outer shell having a passage there through and the second rigid material is shaped to sliding engage the passage of the first rigid material.

In an exemplary embodiment, wherein the elastic material is configured to retain the rigid material in the collapsed configuration, and the rigid material includes a lock to resist a bias imposed by the elastic material and retain the rigid material in the expanded configuration when engaged.

In an exemplary embodiment, further comprising a GPS locator.

In an exemplary embodiment, further comprising a bar code scanner.

In an exemplary embodiment, wherein the rigid material includes at least four indentations to accept, position, and orient the elastic material into two retention areas on a front surface of the rigid material.

In a further exemplary embodiment, a shopping cart, comprising: a basket area, and an organizer attached to the shopping cart, wherein the organizer comprises a rigid material, a retention feature configured to retain an inserted material between the retention feature and the rigid material, and a connector to couple the organizer to a desired surface of the shopping cart.

In a further exemplary embodiment, a method of organizing shopping materials while in motion during a shopping experience, comprising: attaching an organizer to a first rail of a shopping cart, the organizer including a rigid material and a retention feature configured to retain the shopping materials between the retention feature and the rigid material; positioning the organizer in a first position for use during the shopping experience; inserting shopping materials into the retention feature; removing the shopping materials from the retention feature; reorienting the organizer into a second position different than the first position for storage of the shopping cart.

In an exemplary embodiment, wherein the organizer is repositioned from the first position to the second position by rotating the organizer about an axis parallel to an edge of the organizer.

In an exemplary embodiment, wherein the first position supports the organizer between an edge of the basket area and an edge traversing the basket area, and the second position parallel to the edge traversing the basket area.

Exemplary embodiments of the organizer may include a frictional grummet for holding a writing utensil, or a hole, attachment, clip, clamp, spring, chord, or band that accommodates and/or retains a writing utensil.

Exemplary embodiments of the organizer may be secured on the shopping cart by one or more of a variety of attachments. The attachments may be fastened, coupled, molded, separable, or integrated with the organizer. The connectors may be designed for use in all varieties of weather from extreme hot to extreme cold temperatures, wet and dry conditions, ice and wind conditions. The organizer may also be sufficiently rugged to permit an acceptable reusable life span given the use of a typical shopping cart.

Exemplary embodiments of the organizer may be configured to permanently attach to a shopping cart or may be removably attached to the shopping cart. The organizer can be retro fitted to a shopping cart already in service with one or more of a variety of attachments that meet the manufacturer's specifications. The organizer may also or alternatively be fitted to a shopping cart during the manufacturing process of the cart. The organizer may also or alternatively be fitted to a shopping cart for a single use by a customer and removed at the end of use, to be refitted at a later use. The organizer may include one or more connectors for attachment to one or more different configurations of carts or desired attachment orientations or locations.

Exemplary embodiments of the organizer may be permanently attached to said shopping cart while not in use, and readily available when needed. The organizer may use minimal space when not in use, such that the organizer does not interfere with retaining the shopping cart in a nested or storage position.

Exemplary embodiments of the organizer enables the shopper to sort through coupons while retaining the coupons to the organizer by permitting the coupons to move relative to one another.

### BRIEF DESCRIPTION OF THE DRAWINGS

FIG. 1 illustrates and exemplary embodiment of an organizer attachment with elastic chords to secure shopping lists and coupons to the organizer;

FIG. 2. illustrates and exemplary organizer attached to a shopping cart according to embodiments described herein;

FIG. 3 illustrates and exemplary organizer with clips to secure shopping list and coupons to the organizer;

FIG. 4 illustrates and exemplary back side of the organizer with attachment clips;

FIG. 5 illustrates and exemplary organizer with elastic bands to secure shopping list and coupons to the organizer;

FIG. 6 illustrates and exemplary organizer with elastic cord placed on the bottom edge;

FIG. 7 illustrates an exemplary organizer attached to a shopping cart according to embodiments described herein;

FIG. 8 illustrates and exemplary organizer with the elastic band running on the top edge of the organizer;

FIG. 9 illustrates and exemplary organizer with elastic cords and a hook and loop fastener at a bottom of the organizer;

FIG. 9A illustrates an exemplary side view of the organizer of FIG. 9;

FIG. 10 illustrates an exemplary organizer with elastic cords on three sides, to secure shopping list and, or coupons to organizer;

FIG. 11 illustrates an exemplary organizer with a spring clip, and two sliding clips used to secure a shopping list and coupons;

FIG. 12 illustrates and exemplary organizer with springs used to secure shopping list and coupons to organizer;

FIG. 13 illustrates and exemplary organizer with elastic bands used to secure shopping list and coupons to organizer;

FIG. 13A illustrates a cut away of an exemplary tab used to hold the elastic band of FIG.

13;

FIG. 14 illustrates an exemplary organizer with elastic cords used to secure shopping list and coupons to organizer, with an exemplary attached calculator;

FIG. 15 illustrates an exemplary retractable organizer that is collapsed into half its size when not in use;

FIG. 16 illustrates an exemplary retractable organizer in a separated extended configuration;

FIG. 17 illustrates an exemplary retractable organizer in an extended and attached configuration;

FIG. 18 illustrates a cross sectional view of an exemplary retractable organizer.

FIG. 18A illustrates a side view of FIG. 18;

FIG. 18B illustrates a side view of an exemplary corresponding portion of FIG. 18A;

FIG. 19 illustrates an exemplary connector;

FIG. 20 illustrates an exemplary connector;

FIG. 21 illustrates an exemplary connector;

FIG. 22 illustrates an exemplary connector;

FIG. 23 illustrates an exemplary connector;

FIG. 24 illustrates an exemplary connector;

FIG. 25 illustrates an exemplary connector;

FIG. 26 illustrates an exemplary connector;

FIG. 27 illustrates an exemplary connector;

FIG. 28 illustrates an exemplary connector;

FIG. 29 illustrates an exemplary frictional grommet used to hold a writing utensil on organizer;

FIG. 29A illustrates an exemplary frictional grommet holding a writing utensil on organizer;

FIG. 29B illustrates an exemplary writing utensil with elastic band to couple to an organizer;

FIG. 30 illustrates an exemplary organizer that folds open to give twice the area to use while shopping;

FIG. 31 illustrates an exemplary organizer including an exemplary attached device;

FIG. 32 illustrates an exemplary organizer including an exemplary attached device;

FIG. 33 illustrates an exemplary connector; and

FIG. 34 illustrates a child seat section of a shopping cart incorporating an exemplary organizer according to embodiments described herein.

### DETAILED DESCRIPTION OF THE INVENTION

The following detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention. It should be understood that the drawings are diagrammatic and schematic representations of exemplary embodiments of the invention, and are not limiting of the present invention nor are they necessarily drawn to scale.

An organizer is generally shown and described to provide a convenient retention and retrieval location for coupons during a shopping trip. Embodiments may include one or more first interfaces or connectors for retaining coupons. Embodiments may also include one or more second interfaces or connector for securely attaching the organizer to a shopping cart, basket, or carrier. The one or more first interfaces and/or one or more second interfaces may be interchangeable with themselves or between the interface types such that the organizer may be dynamically changed to accommodate the retention needs of the use and/or attachment needs to another object. Embodiments as described herein may also include one or more devices coupled to the organizer to assist in the shopping experience.

Although embodiments described and illustrated herein may be in terms of a coupon organizer for a shopping cart, it should be understood that embodiments of this invention are not so limited, but are additionally applicable to attachment to any interface such as for attachment to golf carts, delivery vehicles, memo boards at home, at schools and universities, or may be retained independent of another physical object. Moreover, additional or different items may be stored in or on the organizer and is not limited to coupons, such as notes, cards, business cards, papers, receipts, score cards and other information containing material. An elastic material is described for creating one or more retention areas. The elastic material may be any material that changes one or more dimensions and/or shape to accommodate the inserted material and provides a retention force on the inserted material to retain the material to the rigid material of the organizer. The elastic material may include non-elastic sections or portions. Therefore, the elastic material may be, for example, an elastic band or strip, coiled or spring wire, resilient fingers or clasps, or may be a rigid bar that includes an elastic section.

FIG. 2 illustrates an exemplary organizer 2 coupled to an exemplary shopping cart 4 according to embodiments described herein. The organizer 2 may be coupled to the handle, basket edge, seat, retractable infant seating area, or other portions of the cart 4. The organizer 2 may provide a sufficient retention surface to support the attached coupons. The organizer may be sufficiently rigid to span one or more attachment points to the cart while sufficiently supporting the attached coupons and providing a retention surface for the coupons. The organizer may also be flexible to accommodate different orientations, configurations, or attachments to a cart. The organizer may be sufficiently rigid, while being flexible to retain a general shape once attached to a cart to supply the necessary support and retention of the coupons in a desired location. The organizer may be non-flexible to provide a non-movable support for the retained coupons and provide a support surface. The support surface may provide a writing surface for a user.

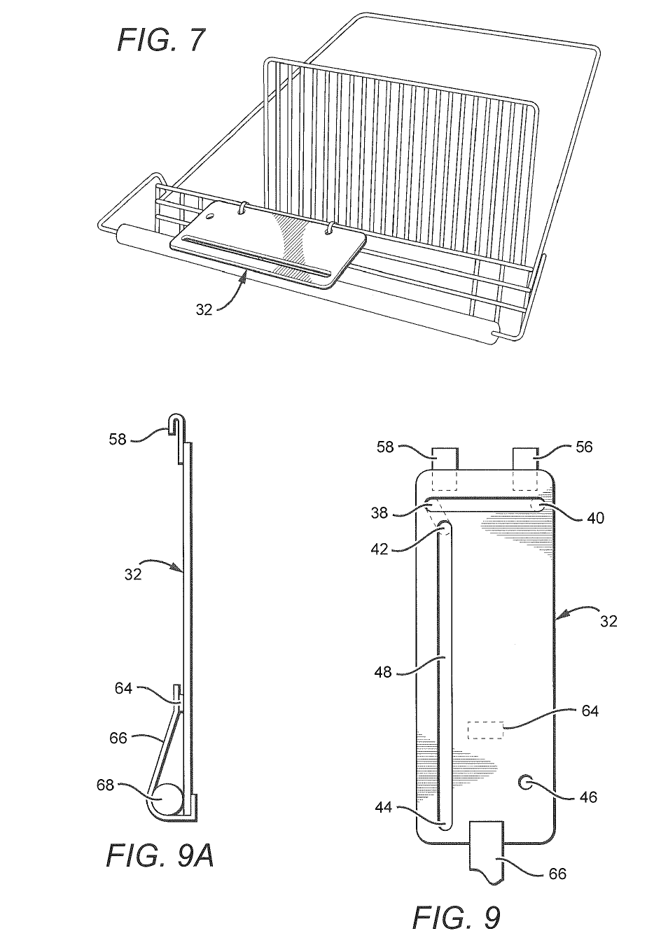

As seen in an exemplary embodiment of FIG. 2, a piece of rigid material 32 of any size used for writing, drawing, or organizing materials by a human being while in motion. The piece of rigid material 32 can be made of a variety of materials such as plastic, compact plastic materials, steel plastic, fiber filled material, glass filled materials, ABS nylon, nylon, delron, press board, plywood, polycarbonate sheets, vinyl, acrylic sheets, fiberglass, formica, hard-board, stainless steel, aluminum, tin, galvanized metal, rubber, carbon fiber. The rigid material 32 may be of different configurations to accommodate the desired attachment and orientation for use. For example, as seen in FIG. 2, the rigid material 32 may be generally rectangular. The rigid material may have a narrow dimension to permit attachment of desired items, but narrow to reduce the interference with the basket space. The rigid material may have a long dimension sufficient to span desired support surfaces, such as the basket edges, the child seat edges, the handle, or a combination thereof. As seen in FIG. 7, the narrow dimension may be sufficiently sized to span the desired support surfaces, such as for example, the handle and cart edge. Other configurations may also be used. For example, as seen in FIG. 8, the generally rectangular region may include a flanged extension that may be used to create a support surface. The extension may generally extend to a top surface of the rigid material in one direction, with a third dimension less than a dimension of the generally rectangular section perpendicular to the direction of extension. For example, as seen in FIG. 8, a generally rectangular section may include a narrow dimension and a long dimension. An extension may project from a side of the long dimension for an extent lesser than the entire long dimension. The projection may include an attachment surface for additional devices or include an attachment mechanism for the desired support surface. The exemplary organizer may be incorporated into one or more features of the cart. As shown in FIG. 34, the exemplary organizer is integrated into the child seat 116 including elastic material 48 directly onto cart 118.

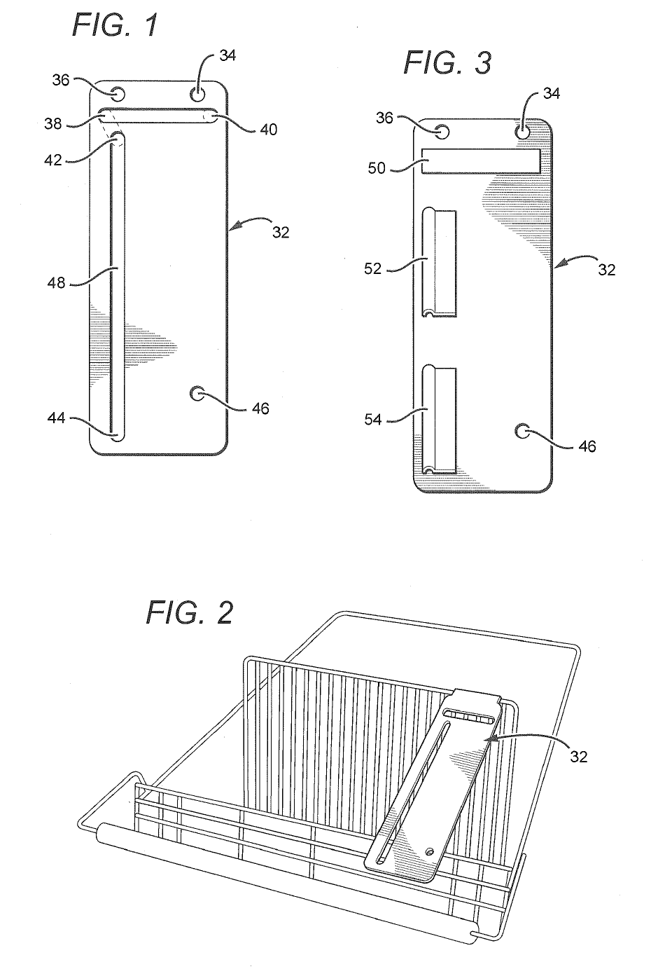

As shown in FIG. 1, the hole 34, hole 36, hole 38, hole 40, hole 42, and hole 44, are recesses made in the piece of rigid material 32. Elastic material 48, such as a band or cord, may be threaded through one or more of the holes 34, 36, 38, 40, 42, and 44 to secure articles, papers, coupons, shopping list, pencil, or other objects placed between the elastic material 48 and the piece of rigid material 32. For example, the elastic material 48 may be secured to the back of the rigid material 34 near hole 40, then laced through hole 40, pulled over a front surface of the rigid material 34, through hole 38, laced under and up through hole 42, along the front surface of rigid material 34, then through hole 44, where the elastic material is secured to the backside of rigid material 34. The elastic material may be secured to the back side by being knotted, tied, clipped, snapped, riveted, adhered, bonded, or otherwise secured with the appropriate tension needed to secure the desired retained material being held in place by the elastic material. One or both ends of the elastic material may be shaped to traverse the hole in one configuration, but retained in a second configuration. For example, the elastic material may include a cross bar that when oriented parallel to the elastic material traverses the hole, but when angled perpendicular to the hole retains the elastic material in place. The end of the elastic material may also be shaped to provide only one way insertion into a hole. For example, the end of the elastic material may be barbed or arrow shaped that compresses when inserted into the hole, but catches when reversed. The elastic material may be durable and suitable for various weather conditions including extreme heat, extreme cold.

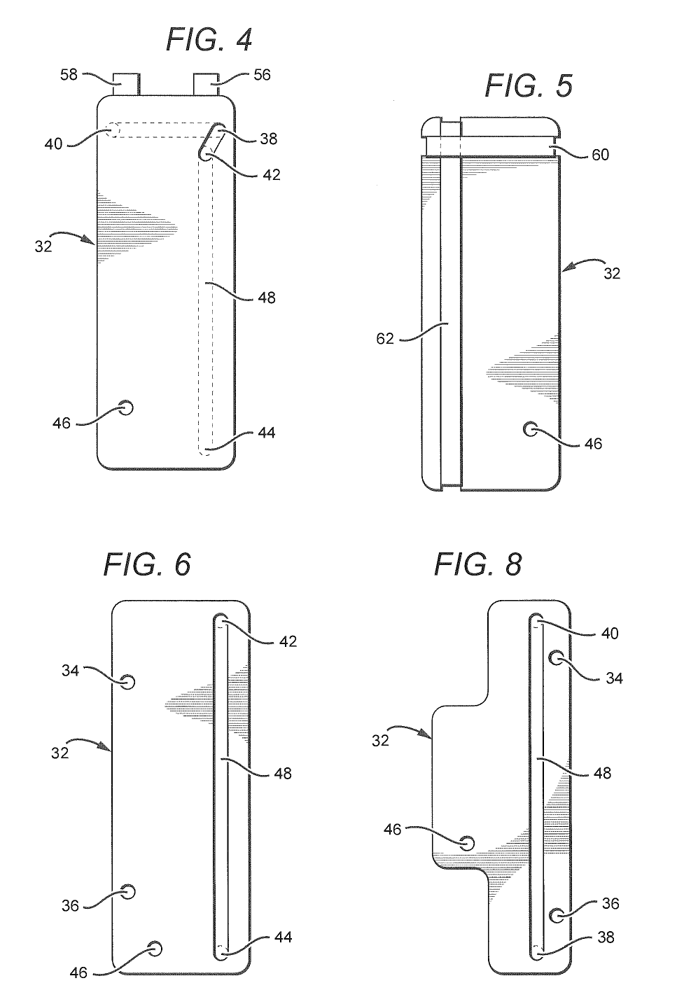

FIG. 4 illustrates the back surface of the organizer of FIG. 1, with the elastic material 48 tied at hole 44, laced through hole 42 and along the back surface and through hole 38, and finally tied, clipped, or otherwise secured at hole 40.

The elastic material may be configured through the one or more holes 34, 36, 38, 40, 42, 44, and 46 to create a desired pattern of retention. For example, the elastic material may be threaded through the holes as shown in FIG. 1 to provide two sections of retention oriented perpendicular from one another. The perpendicular retention sections may over lap such that one retention section occurs along the length of the other retention section. Alternatively, the retention sections may not overlap. As shown, the retention sections may be along a perimeter section of the rigid material 34 and oriented generally perpendicular. The elastic band may also be threaded between holes 40 and 44 to create an angled retention band.

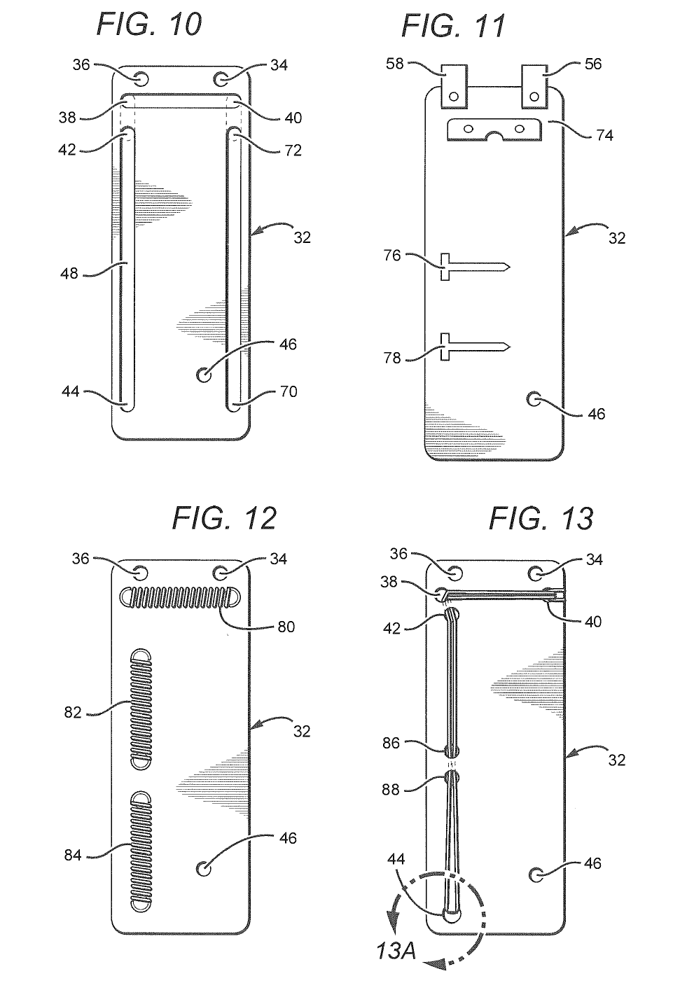

FIG. 10 illustrates an exemplary arrangement of holes 34, 36, 38, 40, 42, 44, 46, 70, and 72 to include a third elastic retention area. As shown, an elastic material is threaded through the one or more holes to create three retention areas along a front surface of the exemplary organizer. Each retention area may be generally parallel to a respective edge of the rigid material and traverse a majority of the exterior edge adjacent the corresponding edge of the rigid material. The retention areas may be configured so that they overlap in extent or are separated as described above. FIG. 10 illustrates the elastic material 48 placed on the rigid material 32 along a top edge, and both lateral sides. In an exemplary embodiment the elastic material is tied at hole 70, on the back side and laced over the top side of 32 placed through hole 72 laced up through hole 40, over the top surface of the rigid material and placed through hole 38, laced up through hole 42, then laced over the top surface of the rigid material 32 and placed through hole 44, where it is tied on the back side of the rigid material. This enables the shopper to have a variety of area to secure the papers such as coupons, shopping list, while the shopping cart is in motion.

The rigid material 32 may also be contoured or otherwise shaped to accommodate the retention feature, such as the elastic material. For example, as seen in FIG. 5, the perimeter edge of the rigid material may include indentations to accommodate an elastic band. The elastic bands may traverse a surface of the rigid material generally parallel to an edge of the rigid material near an exterior region of the rigid material. The indentations may also be configured to orient the elastic bands 60 is different orientations. Therefore, as shown the indentations are generally rectangular cut outs that have an interior edge parallel to an exterior edge of the rigid material. The interior edge of the cut out orients the elastic band 60 perpendicular to that edge. The interior edge may also be angled with respect to the exterior edge of the rigid material so that the elastic band orientated perpendicular to the interior edge traverses the organizer in a direction oblique to the exterior edge. As shown, two pairs of cut outs are provided on opposing sides of the rigid material for positioning two separate elastic bands. However, any number and orientation of cut outs may be used to support or include any number and orientation of elastic bands.

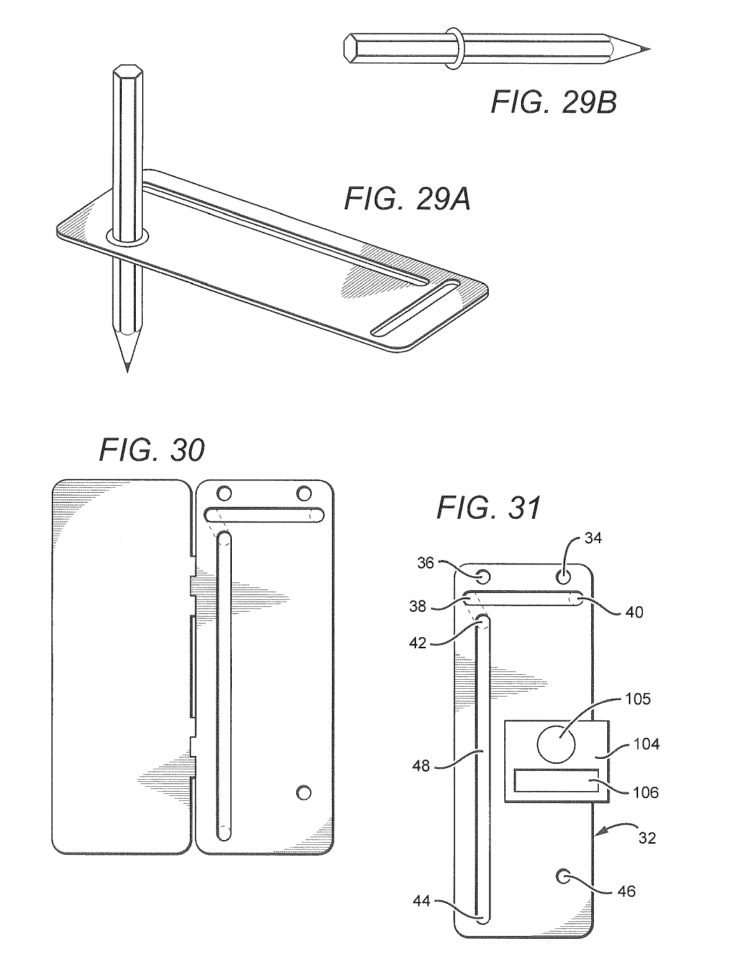

One or more of the holes may be used for securing a writing utensil, or retaining the organizer to the cart. For example, hole 46 may be used to secure a writing utensil, as seen in FIG. 29B, to the rigid material 32. The writing utensil is placed through hole 46 and hangs in a vertical position while the shopping cart is in motion. An optional frictional grommet 120 may be used circumscribing either the hole 46 or the writing utensil. The frictional grommet 120 made be composed of a variety of materials, such as, for example, rubber, nylon, metal, or a combination thereof. The frictional grommet 120 acts as a frictional holder when placed in the hole 46. FIG. 29A, illustrates the writing utensil in position within reach of the human being using the exemplary organizer. Hole 34, and hole 36, are used to attach the piece of rigid material to a shopping cart or any other surface, or object that the rigid material 34 is mounted on. A variety of connectors, such as for example, those shown in FIGS. 19, 20, 27, and 28, may be used to attach the rigid material 34 to a desired surface.

One or more holes 34, 36, 38, 40, 42, 44, 46 may be used to couple attachment mechanisms to the rigid material 32. For example, as seen in FIG. 4, holes 34 and 36 may be used for attachment clips 56 and 58 to fastened the rigid material 32 to a cart. Attachment clips may be similar to those described herein, for example, FIGS. 19 and 20. Alternatively, as shown in FIGS. 27 and 28, closed attachments or flexible attachments may be used for securing to carts already in service. The attachment mechanism may be used with screws, rivets, knobs, buttons, etc. to permanently or removably attach the exemplary organizer to a desired surface.

As seen in FIGS. 1-4, the various holes provide a configurable organizer that may be used in a variety of ways for attachment to a variety of surfaces. The various holes permit the retention feature, such as the elastic material, to be configured in a desired orientation. The holes also permit the attachment mechanisms to be oriented along one or more edges or body of the rigid material to attach the exemplary organizer to various desired surfaces. The holes may also be used to attach one or more other devices, such as the writing utensil, to the rigid material.

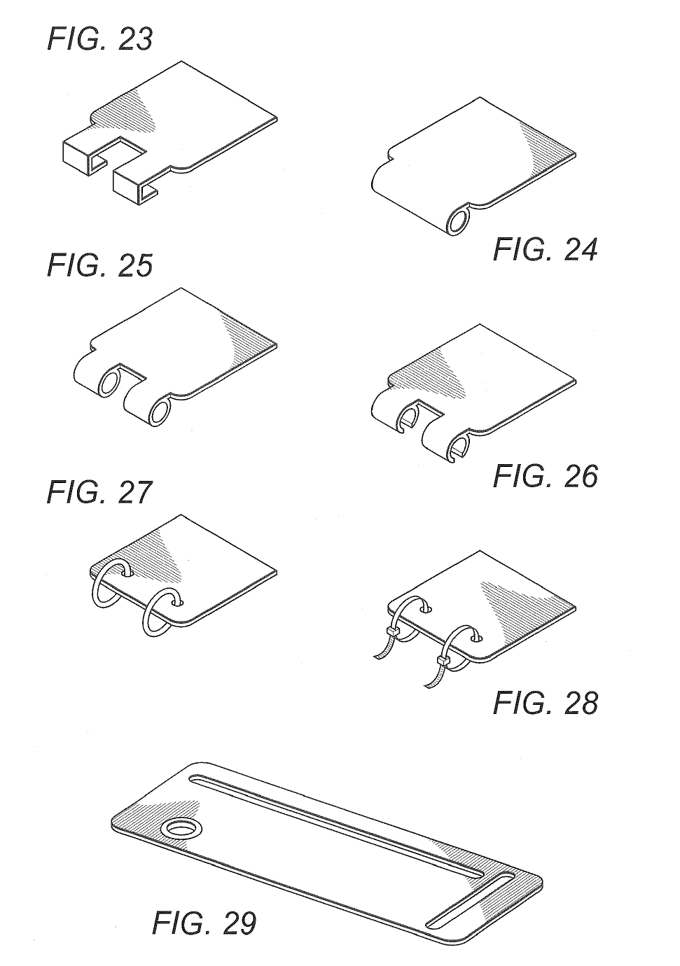

Clips as illustrated, for example, in FIGS. 19-20, 22-23, and 26 may be made of a variety of materials, including plastic, stainless steel, aluminum, nylon, rubber, chrome plated, tin, galvanized metal, etc. The clip may either be coupled to a desired surface, such as in FIG. 20 and clip onto the rigid material 34 through the one or more holes. Alternatively, or in addition, the clip may be coupled to the rigid material and clip onto the desired surface. The clips may be spring clips, resilient fingers, flexible edges, etc. to provide a frictional retention of the clip to the coupled surface, either the desired surface or the rigid material. The clip may be coupled to the rigid material, such as in exemplary illustrates of FIGS. 19-20, or may be integrally formed, such as in exemplary illustrations, FIGS. 22-23 and 26. FIGS. 19 and 23 illustrates an exemplary clip in which a portion of the clip includes an indentation that provide a space for the desired surface to rest within. The indention is created by a projection from the back surface and an overhang over the back surface. The overhang may be configured to angle toward the back surface, such that the overhang is resiliently separated from the back surface to engage an inserted desired surface. An outer lip, not shown, of the overhang may be configured to guide or inserted surface into the indention created by the overhang. The overhang may alternatively be parallel to the back surface. Alternatively, a clip may be provided to generally encircle a desired surface, such as the wire edge of a cart. The clip may include a resilient outer edge that permits the clip to expand to permit entry of the desired surface. The clip edge is biased to return towards a closed position, such that the clip circumscribes more than half of the inserted surface. The clips may be oriented such that a desired surface is inserted generally parallel to the rigid surface or generally perpendicular to the desired surface, or any combination or orientation, therebetween.

FIGS. 20-21, 24-25 illustrate exemplary attachment mechanisms that may permanently or semi-permanently attach the exemplary organizer to a desired surface. For example, the attachment mechanism may include a projection from the rigid material and integrally transition into an attachment area that fully circumscribes the desired surface. FIGS. 21-26 illustrates attachments that are molded onto the rigid material 34 on either the top edge, bottom edge, or one of the two lateral sides, depending on manufactures needs. These attachments may be placed on the support bar, or other desired surface, during the shopping cart manufacturing process.

Other attachment mechanism may also be used, such as those illustrated in FIGS. 27-28. A ring clip is illustrated in FIG. 27. The ring may be configured to permanently or removably attach the organizer to the desired surface. For example, the ring may be a complete, solid ring circumscribing a desired surface and retaining the rigid surface through one or more holes. The ring may also include a clasp, detented mating surface, hinge, etc. to permit removable attachment. The ring may also be spiraled, overlapped, or resilient to provide a closed configuration that retains the rigid material, but that is removable, such as for example like a key ring. An alternative ring clip is provided in FIG. 28. FIG. 28 illustrates exemplary tie wraps used to retrofit shopping carts that may already be in the field and in use.

One or more clips may use the rigid material itself to create one of the clipping surfaces, such that the clip 52 and 54 with the rigid material retains the inserted surface. For example, as seen in FIG. 3, clips 52, 54 may be along a body portion of the rigid material, such as extending from a back surface of the rigid material. The back surface may then be used in conjunction with an inwardly facing surface of the clip to retain a desired surface. The clip may be resilient to permit the clip to separate from the rigid material when inserting a surface, but be biased to return toward the rigid material to fictionally engage the inserted surface.

Additional or other attachment features may be used. For example, attachment strip 50 may be used to mate with a desired surface directly or a complementary attachment strip on the desired surface. The attachment strip 50 may be an adhesive strip or other fastening strip, such as one side of a hook and loop fastener. The attachment strip may be along a surface of the rigid material, such as a back surface as shown in FIG. 3. A corresponding strip may be on the desired attachment surface to permanently, semi-permanently, or removably couple the rigid material to the desired surface. The attachment strip 66 may alternatively be along an edge of the rigid material, as seen in FIGS. 9 and 9A. For example, a hook and loop strip may be along a bottom edge of the rigid material such that one side of the strip 66 engages a complementary strip 64 on the rigid material 32. The strip 66 may be used to retain the exemplary organizer to the cart handle 68, or other desirable surface. The strip 66 may be coupled to the rigid material in any secure manner, such as sewing, gluing, adhering, looped through a hole, snap, clip, etc.

One or more attachment mechanisms may be used in combination to couple the exemplary organizer in a desired orientation to a desired surface. For example, integrated permanent attachment mechanisms may be used along one edge of the exemplary organizer to permanently retain the organizer to a cart, but may use one or more clip or removable attachment mechanisms along a second edge to orient the organizer in a desired configuration during use. The removable attachment may be used to store the organizer in a compact position when not in use, while the permanent attachment prevents theft of the organizer.

For example, FIG. 2 illustrates one exemplary orientation of an exemplary organizer secured to a shopping cart by the top edge. The rigid material 34 may be coupled along its top edge to the expandable baby basket of the cart. When in use, the top edge is supported by the basket and the bottom edge may rest or use a separate attachment mechanism to couple to the outer edge of the basket or the handle. When not in use the rigid material is rotated parallel to the back rest of the child seat. For example, the rigid material may be swung over and rest on the back of the child seat when the shopping cart is put in their nesting position. FIG. 7 illustrates an alternate exemplary attachment configuration. As seen in FIG. 7, the attachment mechanism may be along a lateral edge of the organizer so that the organizer spans the area between the basket and the handle. In this case, the attachment mechanism may couple the organizer to an outer edge of the basket, and may rotate around the outer rim such that the organizer may rest along the handle or rest along the basket outer edge.

Thus, the holes, attachment mechanisms, and/or retention features may be configured in various patterns to permit different use configurations of the exemplary organizer. The holes may be incorporated such that only one or a select configuration is permitted, or may be incorporated that any number of configurations may be used. FIG. 6 illustrates an exemplary organizer with hole 34 and hole 36 on a lateral side of the organizer for mounting said piece of rigid material parallel to a shopping cart handle. This hole configuration may be incorporated or superimposed on top of the hole configuration, of for example, FIG. 1 such that the organizer may be coupled in either orientation.

As shown and described, an elastic material is used to retain the desired materials of coupons, shopping lists, notes, advertisements, etc. Other retention features may also be used alone or in combination. The various retention features may be used in any combination, recombination, subcombination, or configuration as would be desirable for the given use. Exemplary embodiments illustrating exemplary embodiments are described herein, but the invention is not so limited. The various retention features may be used in combination with the above described holes to afford a configurable organizer. Alternatively, the retention features may be coupled to the organizer in various manners such as through screws, rivets, self attachment, bolt, adhesive, bond, etc. either permanently, semi-permanently, or removably.

For example, FIG. 11 illustrates spring clamp 74 used to secure papers to the rigid material 32. Slip clamps 76, and 78 are may also be used to secure paper coupons, or shopping list to the rigid material 32 by placing them between slip clamps 76, and 78 and the rigid material. Spring clip 74 may have a retaining surface of a longitudinal length. The spring clip may include a detent or other hook to permit a user to easily and conveniently rotate the clip into an open position to insert the desired materials within the clip. The spring clip is then biased to rotate the clip toward the rigid material and retain the inserted material therein. Slip clips may similar retain inserted material. The slip clip may include an interior surface that rests against a corresponding surface or the rigid material. An inserted material is retained in the slip clip when the clip expands through the insertion of the material and is frictionally engaged as the clip tends to push in the direction of its original orientation against the rigid surface. One or more slip clips may be used with one or more prongs to fully secure an inserted material.

FIG. 12 illustrates an exemplary embodiment using an elastic material of springs 80, 82, and 84. Similar to the elastic material describe above with respect to FIG. 1, one or more springs may be used to secure material to the rigid material 32. As shown three separate springs are used. The spring may be threaded through various holes, similar to the above elastic material, or may be separately connected to the rigid material. As shown, the springs are riveted or bolted to the rigid material separately. FIG. 12 illustrates an alternate configuration of the retention area including three retention areas. The retention areas parallel to and adjacent to two sides of the rigid material, such that two retention features are longitudinally aligned and perpendicular to a third retention feature.

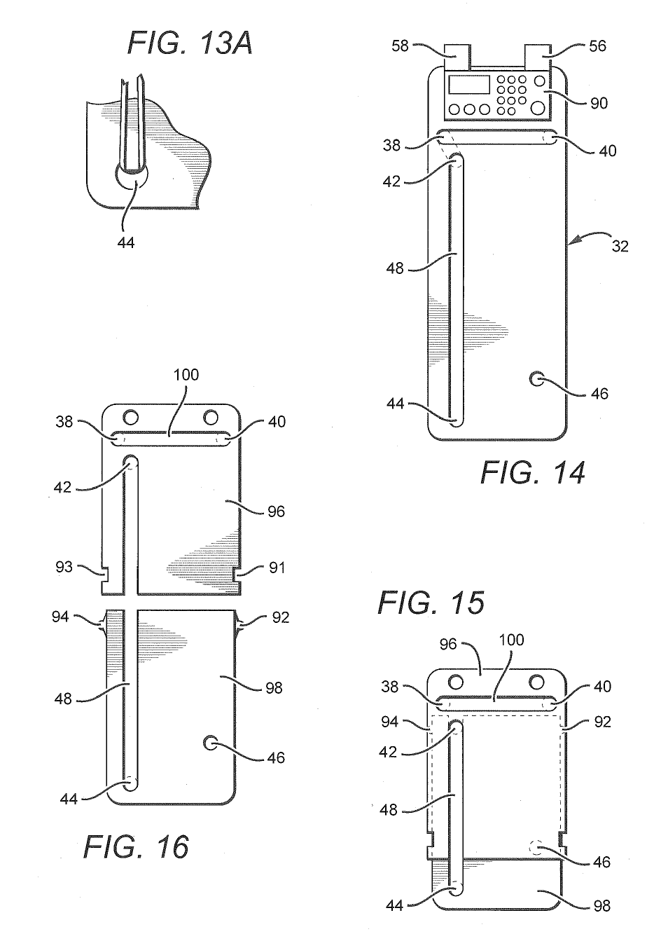

FIG. 13 illustrates an exemplary embodiment with rubber band material running from hole 40, where it is tied then runs over the top face of the rigid material 62, goes down through hole 38, then is laced up through hole 42, then over the top face of the rigid material 32, then down through hole 86, laced up through hole 88, then connects to tab located at hole 44. FIG. 13A highlights the tab at hole 44. The bands secure papers between the rubber band material and the rigid material 32. FIG. 13 illustrates three retention areas similar to FIG. 12, in which two features are longitudinally aligned and perpendicular to a third retention feature. The first and second retention features overlap the third retention features and all are generally parallel to an exterior edge along an exterior region of the rigid material.

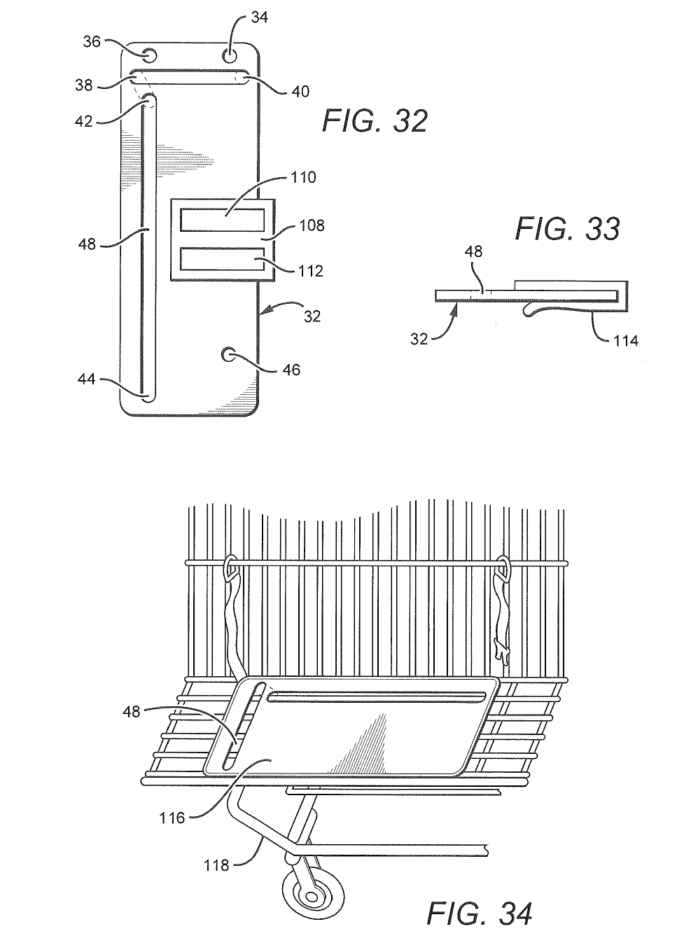

Other devices and features may be used in conjunction with the exemplary organizer. For example, as seen in FIG. 29, a writing utensil, such as a pencil may be retained or coupled to the organizer. FIG. 14 illustrates an exemplary organizer fitted with an elastic cord that is tied at hole 40, and laced through holes 38, and 42 than tied off at hole 44. A calculator 90 is mounted on the rigid material 32, designed for the use by the consumer. The calculator may be secured may various methods such as adhesion, bonding, clipping, pouch, rivets, bolts, screws, or formed integrally therein. Other devices may also be included, such as illustrated in exemplary organizer of FIGS. 31-33. For example, a product locator may be used to assist a shopper in finding a desired item in a store. For example, as seen in FIG. 31, a device may include a GPS product locator 104, voice activated receiver 105, and display 106 for identifying the location of a product within the store. As seen in FIG. 32 a price indicator 108 may be included with a bar code scanner 110 and display window 112 to display a given product price. The price indicator 108 may also be configured to retain a running total of desired products. The added devices may include one or more input/output features such as buttons, wheels, selectors, touch screens, display screens, scanners, sensors, etc. The device may comprise a combination of hardware and/or software to perform the given algorithm. The device may include a processor, memory, and other electronic components to store and compute the desired information. For example, locator logic may be configured to receive GPS information received by the GPS locator, coordinate a given location within the store for a given desired item, and indicate a direction in which the item is located to a user. The GPS locator may update the indicated direction periodically as the shopper moves toward the object. Pricing logic may also be included to receive as input, such as through a bar code scanner, information about a given product. The pricing logic may also be configured to receive a quantity of a product may either taking an input from a user for by scanning the item multiple times. The pricing logic may then be configured to display a description, price, or other information about the product such as nutritional information or source or ingredient information. The pricing logic may also be configured to retaining a running total of desired items by either directly summing the price of any item entered or requesting input from a user to either sum or discard the item scanned. Additionally, the organizer may be used with a portable electronic device, such as a smart phone, smart pad, music player or other electronic interactive device. The portable electronic device may receive satellite, GPS, Wi-Fi signals, or other locating signal and may be used wirelessly to interact with a device coupled to the organizer. In such case, the device may interact with one or more features of the portable electronic device to locate products, display prices, announce sale items, and/or, for example, update shopping specials in the given retail outlet. The portable electronic device may download an application that is configured to work and/or communicate with the device coupled to the organizer. Therefore, the supported electronics of the organizer may be minimized.

The additional shopping items may be coupled to the rigid material in any manner. For example, as shown in FIG. 33, the additional device may be include a clip 114 for retaining to the rigid material 32. The device may be integrally formed to the rigid material or otherwise attached to the rigid material 32. For example, the device may be molded, fitted, fastened, snapped, hook and loop attached, clipped, adhered, bonded, riveted, screwed, bolted, pocketed, etc.

Exemplary embodiments as described herein may also be retractable or otherwise able to be stored in a reduced configuration for easy transport and storage. For example, as shown in FIG. 15, an exemplary organizer may be made of separable sections of rigid material 96 and 98. One rigid material 98 may be configured to slid within an exterior rigid shell 96 as seen in FIGS. 18 and 18A. For example, the rigid material 98 may be configured into an exterior shell, such as for example, with four sides enclosing an interior passage. The rigid material 96 may then generally conform to the interior passage and slide therein. The rigid materials 96 and 98 may be locked or retained in one or more desired configurations, such as an expanded configuration for use and a contracted configuration for storage.

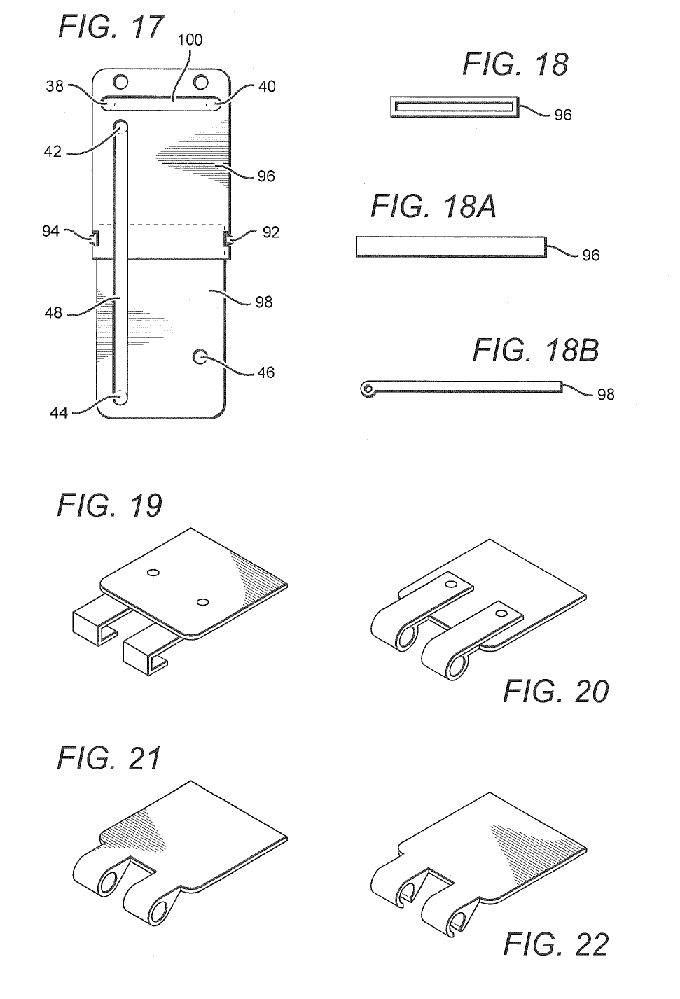

For example, the rigid material 98 may include one or more projections that mate with one or more indentions or holes on the corresponding rigid material 96. When in a expanded configuration as seen in FIG. 17, ready for use, the projections 92, 94 rest within indentations 91, 93 as seen in FIG. 16 and retain the first rigid material 98 to the second rigid material is the desired configuration. When in a collapsed configuration, the retention feature may be used to bias the organizer. For example, a retention feature such as elastic material 48 may be coupled to one end of the first rigid material and to one end of the second rigid material. When the sections are not locked together in an expanded configuration, the elastic material 48 pulls the first rigid material toward the second rigid material and maintains the organizer in a collapsed configuration. Alternatively, other locking features may be included such as a second indention for mating with projections at an opposing end of the rigid material 96. Alternative locking features may also be used. Also illustrated in FIG. 15 is an additional retaining feature 100 separate from the elastic material 48 such that the retention regions do not interfere with the collapse of the device. FIG. 16 illustrates the exemplary organizer in a separated configuration in which the rigid materials on the outside of the exterior rigid material.

FIG. 30 illustrates an alternative embodiment of an expandable organizer. As shown separate rigid material 32 portions may be joined or connected together. As shown, the first rigid material 32a is hinged to a second rigid material 32b to expand a working surface of the organizer or to enclose the materials retained by the retention areas of the organizer. One or more of the rigid materials 32 may include one or more retention areas. The expandable organizer, as shown, includes two rigid material sections, but more may also be included that collapse into a reduced configuration. As shown, this exemplary organizer includes a hinge along the long edge to open up like a book to increase the area used to sort and find coupons while shopping. A retention feature, such as an elastic material, used as a retention area or separate therefrom may be used to secure the expandable organizer in a reduced configuration. For example, retention area 100, as shown in FIG. 15 may be included to wrap around an exterior surface of the rigid material 32a in a collapsed configuration.

The exemplary embodiment of the expandable organizer of FIGS. 15 and 30, may be used by the consumer and carried to the store from home. The reduced configuration permits the easy storage and transport of the organizer, and provides for additional protection and retention of the enclosed material in exemplary embodiment of FIG. 30. Interior rigid material 96 of FIG. 15 may also be configured with an interior chamber for holding and/or retaining materials in the collapsed configuration.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claim:

1. An organizer, comprising:
a rigid material;
a retention feature configured to retain an inserted material between the retention feature and the rigid material; and
a connector to couple the organizer to a desired surface.

2. The organizer of claim 1, wherein the retention feature comprises an elastic material.

3. The organizer of claim 2, wherein the rigid material includes a plurality of holes and the elastic material is threaded through the holes and configured to provide at least two retention areas on a first surface of the rigid material.

4. The organizer of claim 3, wherein at least one of the plurality of holes includes a tab for retaining the elastic material.

5. The organizer of claim 3, wherein the elastic material is oriented through the plurality of holes to create at least three retention areas on the first surface of the rigid material.

6. The organizer of claim 2, wherein the rigid material includes a holder for a writing utensil.

7. The organizer of claim 6, wherein the holder is a hole through the rigid material and the writing utensil is retained in the hole by a grommet.

8. The organizer of claim 2, wherein the connector is at a first end of the organizer and comprises a clip.

9. The organizer of claim 2, further comprising a second connector on an opposite end of the organizer than the connector.

10. The organizer of claim 2, wherein the rigid material is separable into a first rigid material and a second rigid material.

11. The organizer of claim 10, wherein the first rigid material and second rigid material mate in an expanded configuration for use and retract into a collapsed configuration for storage.

12. The organizer of claim 11, wherein the first rigid material comprises an outer shell having a passage there through and the second rigid material is shaped to sliding engage the passage of the first rigid material.

13. The organizer of claim 11, wherein the elastic material is configured to retain the rigid material in the collapsed configuration, and the rigid material includes a lock to resist a bias imposed by the elastic material and retain the rigid material in the expanded configuration when engaged.

14. The organizer of claim 2, further comprising a GPS locator.

15. The organizer of claim 2, further comprising a bar code scanner.

16. The organizer of claim 2, wherein the rigid material includes at least four indentations to accept, position, and orient the elastic material into two retention areas on a front surface of the rigid material.

17. A shopping cart, comprising:
a basket area, and
an organizer attached to the shopping cart, wherein the organizer comprises a rigid material, a retention feature configured to retain an inserted material between the retention feature and the rigid material, and a connector to couple the organizer to a desired surface of the shopping cart.

18. A method of organizing shopping materials while in motion during a shopping experience, comprising:
attaching an organizer to a first rail of a shopping cart, the organizer including a rigid material and a retention feature configured to retain the shopping materials between the retention feature and the rigid material;
positioning the organizer in a first position for use during the shopping experience;
inserting shopping materials into the retention feature;
removing the shopping materials from the retention feature;
reorienting the organizer into a second position different than the first position for storage of the shopping cart.

19. The method of claim 18, wherein the organizer is repositioned from the first position to the second position by rotating the organizer about an axis parallel to an edge of the organizer.

20. The method of claim 19, wherein the first position supports the organizer between an edge of the basket area and an edge traversing the basket area, and the second position parallel to the edge traversing the basket area.
